(19) United States
(12) Patent Application Publication
(10) Pub. No.: US 2016/0313878 A1
(43) Pub. Date: Oct. 27, 2016

(54) APPARATUS AND METHOD FOR PROVIDING A DIGITAL GARAGE

(71) Applicant: Audatex North America, Inc., San Diego, CA (US)

(72) Inventors: Anthony Aquila, Westlake, TX (US); Neal Lowell, II, Roanoke, TX (US)

(21) Appl. No.: 15/138,001

(22) Filed: Apr. 25, 2016

Related U.S. Application Data
(60) Provisional application No. 62/152,485, filed on Apr. 24, 2015.

(51) Int. Cl. G06F 3/0482; G06Q 30/06; G06F 3/0484

(52) U.S. Cl. CPC G06F 3/0482; G06F 3/04845; G06F 3/04842; G06Q 30/0643

(57) ABSTRACT

A device and method that allows a plurality of vehicle subjects to be accessed. The method includes receiving owned vehicle input on an interface provided by a vehicle access application and providing information regarding an owned vehicle. The method also includes receiving not owned vehicle input on an interface provided by the vehicle access application and providing information regarding an not owned vehicle.

### CROSS-REFERENCE TO RELATED APPLICATION

This application claims the benefit of U.S. Patent Application No. 62/152,485.

### BACKGROUND OF THE INVENTION

1. Field of the Invention

The subject matter disclosed generally relates to a method and apparatus for accessing a plurality of vehicle subjects through a single application.

2. Background Information

Purchasing and maintaining a vehicle such as an automobile involves the consideration, analysis and viewing of a large amount of vehicle data and information. For example, the vehicle may need repairs or routine maintenance that require the user to contact a dealer or garage. If there is an accident the user must contact an insurance carrier to file a claim. Diagnostic vehicle information must be retrieved from the vehicle. Any desire to obtain the present value of the vehicle requires the user to access a different source. It would be desirable to provide a product that allows the user to access a variety of vehicle subjects, including the subjects noted above, through a single application.

### BRIEF SUMMARY OF THE INVENTION

A device and method that allows a plurality of vehicle subjects to be accessed. The method includes receiving owned vehicle input on an interface provided by a vehicle access application and providing information regarding an owned vehicle. The method also includes receiving not owned vehicle input on an interface provided by the vehicle access application and providing information regarding an not owned vehicle.

### BRIEF DESCRIPTION OF THE DRAWINGS

FIG. 1 is a schematic of a system that allows a plurality of vehicle subjects to be accessed through a single application;

FIG. 2 is an illustration of log-in screen;

FIG. 3 is an illustration of a navigation screen for different vehicles;

FIG. 4 is an illustration of a screen for a vehicle owned by the user;

FIG. 5 is an illustration of an alerts screen;

FIG. 6 is an illustration of a vehicle information screen;

FIG. 7 is an illustration of a screen shot that provides a comparison of the cost for vehicle options versus the overall cost of the vehicle;

FIG. 8 is an illustration of cost of ownership screen;

FIG. 9 is an illustration of cost of ownership screen;

FIG. 10 is an illustration of cost of ownership screen;

FIG. 11 is an illustration of a vehicle health screen;

FIG. 12 is an illustration of a vehicle health screen;

FIG. 13 is an illustration of a vehicle health screen;

FIG. 14 is an illustration of a vehicle health screen;

FIG. 15 is an illustration of a vehicle health screen;

FIG. 16 is an illustration of an insurance screen;

FIG. 17 is an illustration of an insurance screen;

FIG. 18 is an illustration of an insurance screen;

FIG. 19 is an illustration of an insurance screen;

FIG. 20 is an illustration of a vehicle rating screen;

FIG. 21 is an illustration of driver rating screen;

FIG. 22 is an illustration of a vehicle history screen;

FIG. 23 is an illustration of a trip history screen;

FIG. 24 is an illustration of a repair history screen;

FIG. 25 is an illustration of a vehicle report screen;

FIG. 26 is an illustration of an alert archive screen;

FIG. 27 is an illustration of a speeding alerts history screen;

FIG. 28 is an illustration of a claims history screen;

FIG. 29 is an illustration of a screen shot with selectable icons that relate to the build of a new vehicle;

FIG. 30 is an illustration of screen shot with selectable buttons that allows the user to change or update an ordered vehicle configuration;

FIG. 31 is an illustration of a vehicle build status screen;

FIG. 32 is an illustration of a vehicle delivery screen; and,

FIG. 33 is an illustration of a vehicle delivery contact screen.

### DETAILED DESCRIPTION

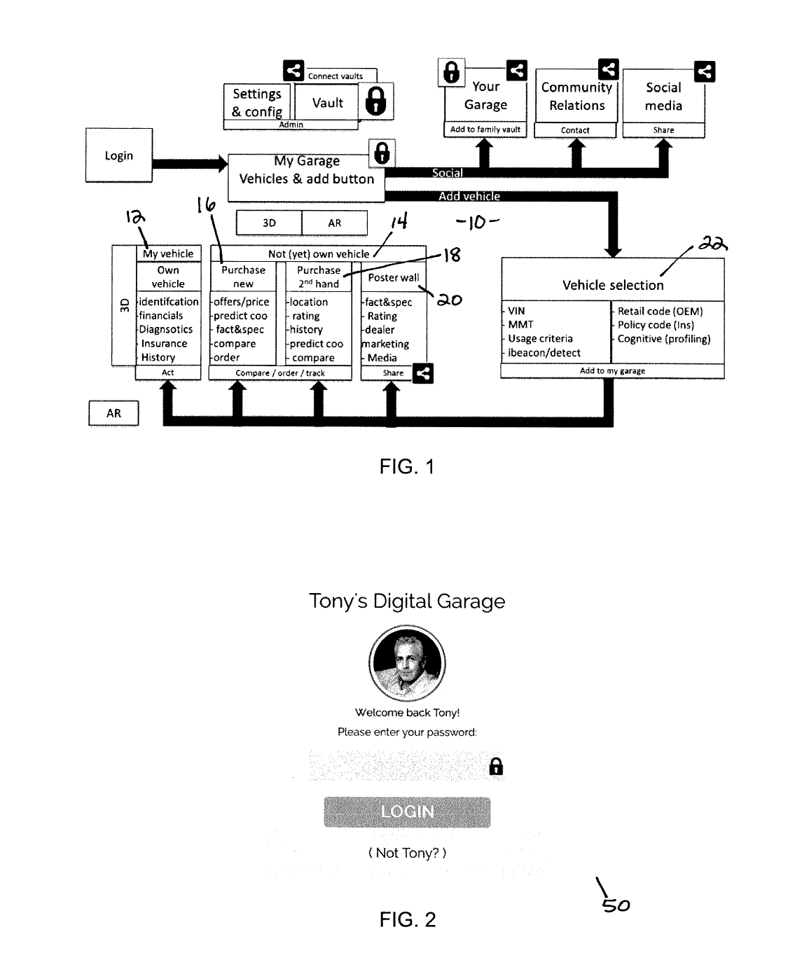

Disclosed is a system and method(s) for accessing a plurality of vehicle subjects through a single application. FIG. 1 shows an overview of an exemplary system 10. The system 10 may include software that operates in one or more electronic devices. For example, the system may include an application that runs on a device such as a personal computer, laptop computer, cell phone, tablet, etc. The device may include a CPU(s), memory and I/O. The application may be software that includes data and instructions that are processed by the CPU. The application may connect to various servers that contain databases, etc. The system may include a portal server(s) that provides an access point for the application and connects to various relevant databases such as insurance, car dealers, vehicle manufactures, vehicle valuation, etc. The system may be implemented in a web based environment. For example, the user can access a portal server(s) by entering a uniform resource locator (URL) through a browser.

The system may include an own vehicle module 12 that provides various data regarding a user's own vehicle, such as an identification of the vehicle, financial data regarding the vehicle, diagnostic and history information of the vehicle, and insurance data. The system 10 may also include a not owned vehicle module 14 that provides various data of vehicles that the user does not own. The module 14 may include a purchase new sub-module 16 and purchase second hand sub-module 18 that provides data on a new vehicle or second hand vehicle that the user may want to purchase. The module 12 may also include a poster wall sub-module 20 that provides data on a vehicle that the user is considering for purchase. There may also be a module 22 that provides data fields that allow a user to select a vehicle that is utilized by the modules 12 and 14. The modules may contain relational databases that correlate data with individual data fields and a relational database management system (RDBMS).

FIG. 2 shows an exemplary login screen 50 that includes a password field and a login button. The user's image may also be displayed by the screen 50.

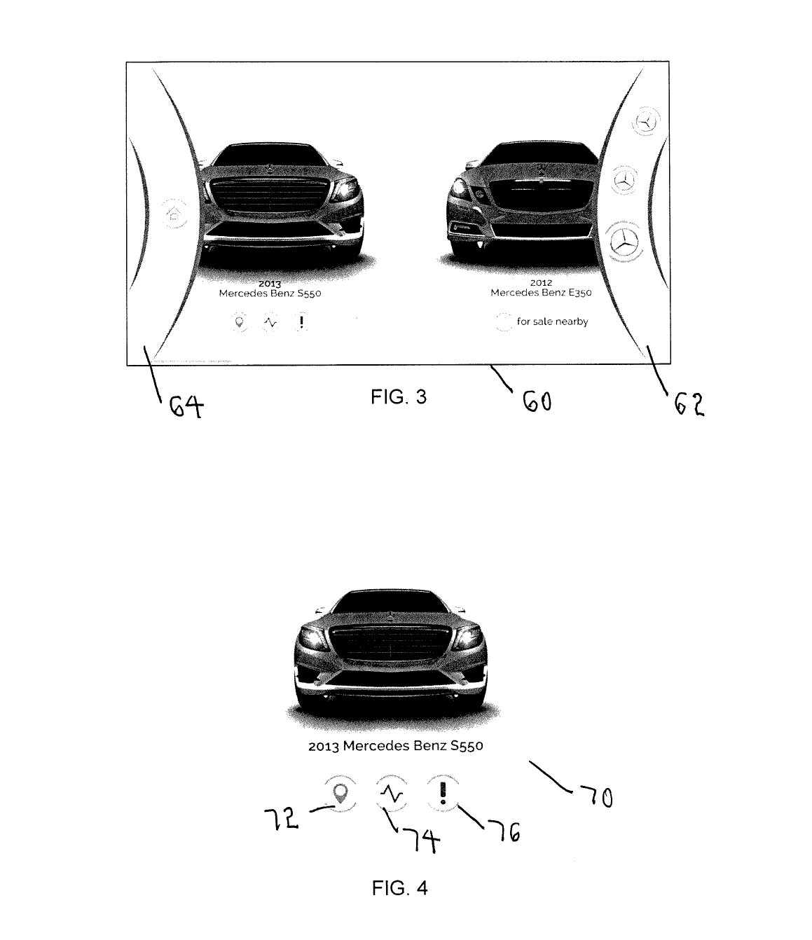

FIG. 3 shows a navigation screen 60 that allows a user to browse through different vehicles. The screen 60 includes a right graphical wheel 62 and a left graphical wheel 64 that can be “rotated” by a user through various input means such as touch, cursor, etc. Rotation of the wheels 62 and 64 may cause the retrieval of relevant data from the not own module 14. The left graphical wheel 64 may include subject icons and the right graphical wheel 62 may include icons that provide sub-categories for each subject. For example, the left graphical wheel 64 may display a vehicle selection icon (e.g. Mercedes). The right graphical wheel 62 may display vehicle model icon (e.g. Mercedes S550).

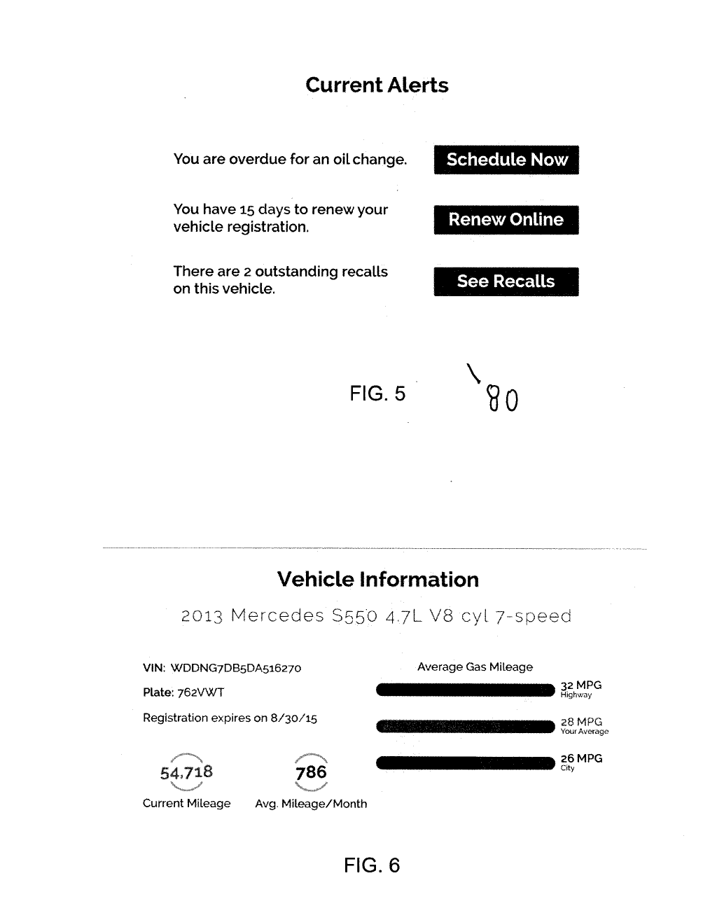

FIG. 4 shows a screen shot 70 for an owned vehicle. That is a vehicle owned by the user. The screen shot 70 may include an image of the vehicle and 3 selectable icons 72, 74 and 76. Icon 72 can be selected to provide a physical location of the vehicle. By way of example, this may be displayed on a map. Icon 76 can be selected to provide alerts regarding the vehicle. FIG. 5 is an exemplary alert screen shot 80 of “Current Alerts” that provides various vehicle alerts. For example, as shown the alerts may remind the user to get an oil change with a graphical button that can be selected that provides a link to an entity that can change the vehicle oil. The alert screen may include a RENEW ONLINE graphical button that when selected links to a relevant department of motor vehicles registration web page.

FIG. 6 shows an exemplary vehicle information screen shot 90 that includes indicators showing average gas mileage. This information can be generated from ODB2 data read from the vehicle that is uplinked to the own vehicle module 12. The screen shot 90 may also contain other information regarding the vehicle such as the license plate number and the vehicle VIN.

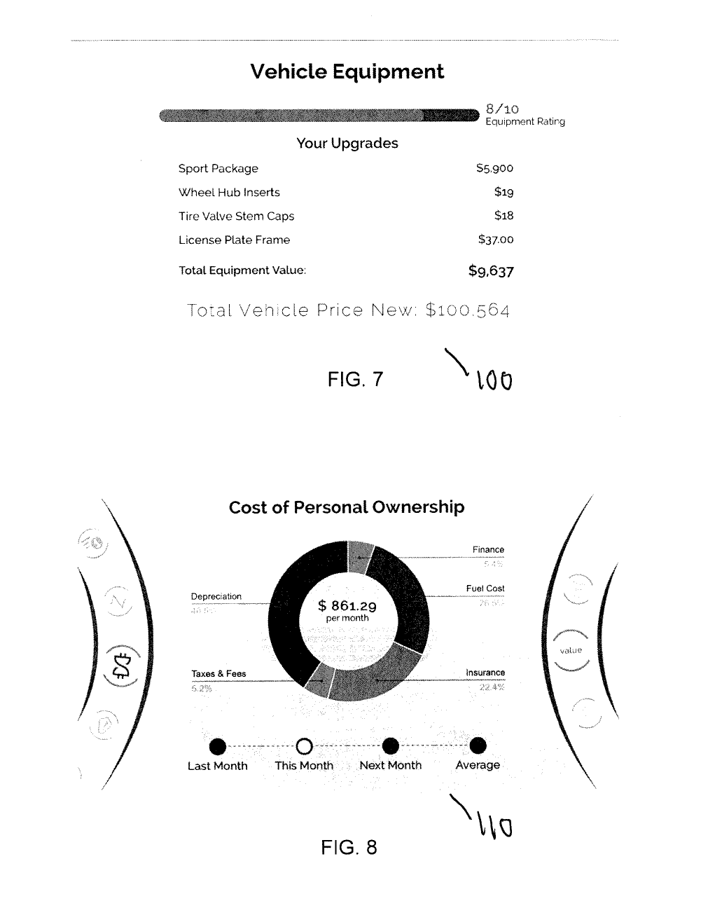

FIG. 7 shows a vehicle equipment screen shot 100 that provides a comparison of the cost for vehicle options versus the overall cost of the vehicle. The screen shot 100 may also provide a vehicle equipment rating based on overall vehicle equipment. This rating may be a function of the vehicle options. This information can be accessed by connecting to a database such as an original equipment guide (“OEG”) database.

FIGS. 8, 9 and 10 provide screen shots 110, 120 and 130, respectively, that provide information that can assist a user in determining the cost of owning the vehicle and whether, and when, it would be suggested to sell the vehicle. FIG. 8 provides a pie chart graphic with individual segments identifying a cost per month in terms of vehicle depreciation, taxes and fees, insurance, fuel cost and finance. If applicable, the finance terms can be entered into a separate setup screen by the user. The fuel cost can be retrieved from a local fuel source database. Likewise, the taxes/fees and insurance cost can be retrieved from relevant databases. The depreciation cost can be determine from an algorithm that utilizes the present value of the vehicle. The present value can be retrieved from a relevant database such as the total loss vehicle database provided by Autosource. The depreciation value is a function of current cost, historical cost and predicted future cost based on certain assumption regarding the supply and demand of a given vehicle. The screen shot 110 can provide selectable icons that allow the user to view past, present and future monthly cost data. The screen 110 can be accessed by rotating a right hand wheel.

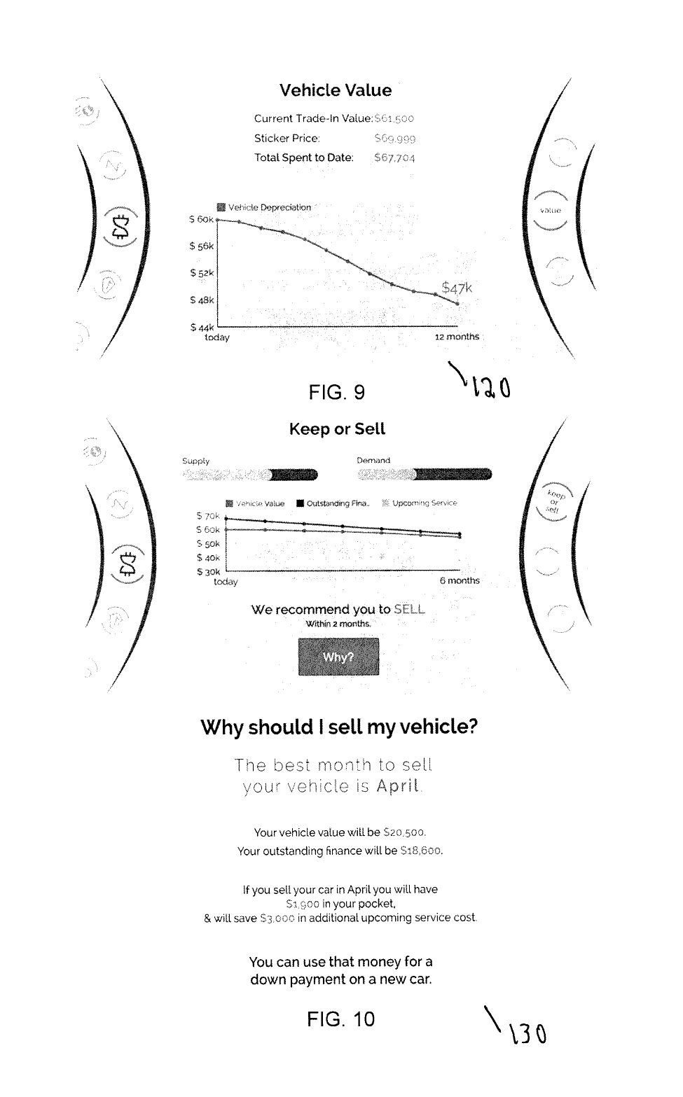

The screen shot 120 shown in FIG. 9 can provide comparative data on the present value of the vehicle and the sticker value. The screen shot 120 can also provide a graphical depiction of vehicle depreciation over time. This data can be generated with a total loss vehicle valuation process.

The FIG. 10 screen shot 130 can provide information that suggest selling the vehicle. This information may provide a comparison of the present value of the vehicle and finance data, and project when the vehicle valuation falls below the finance cost. The system may provide information that suggest a time period for selling the vehicle and data regarding sales profit and money saved.

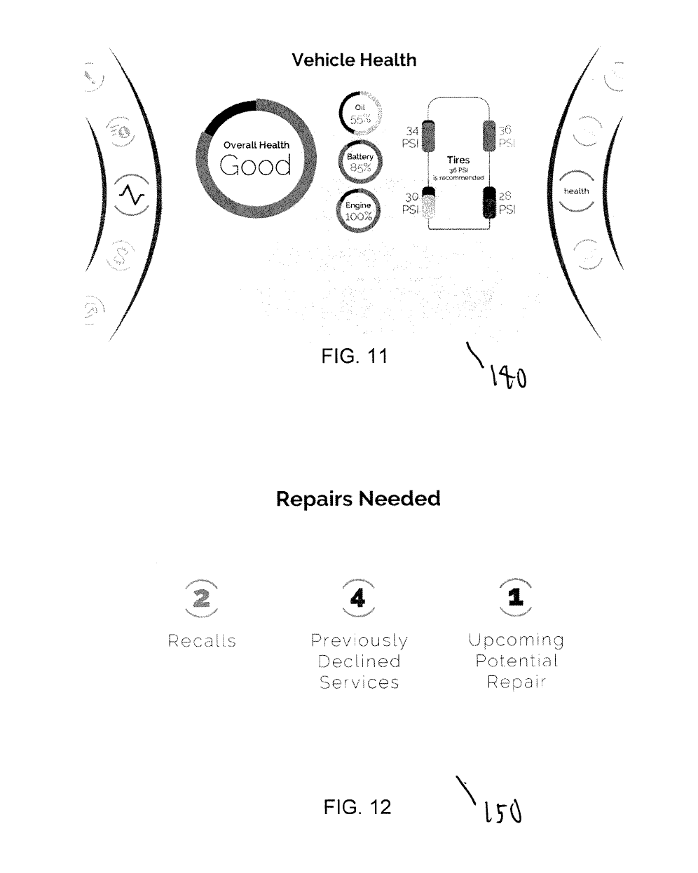

Referring back to FIG. 4, selecting icon 74 may provide information regarding the “health” of the vehicle. FIGS. 11, 12, 13, 14 and 15 show corresponding screen shots 140, 150, 160, 170 and 180. FIG. 11 provides diagnostic information such as tire pressure, oil, battery and engine conditions. This information can be provided by ODB2 data that is read from the vehicle computer and uplinked to the module 12.

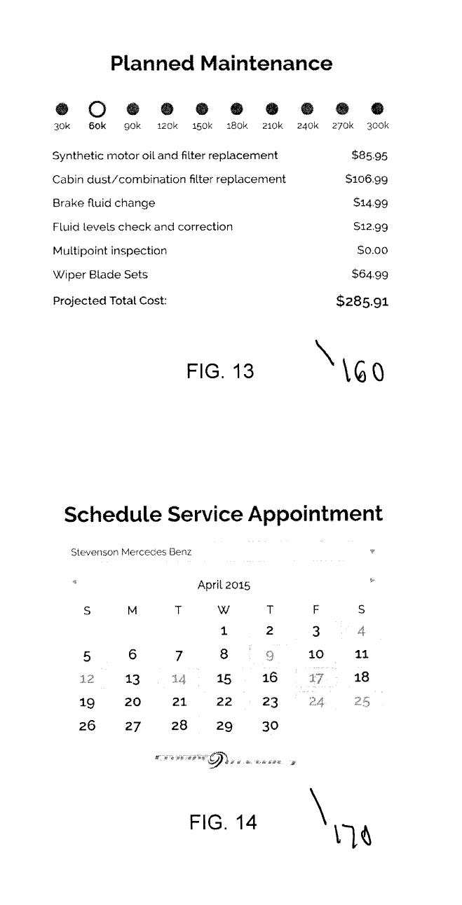

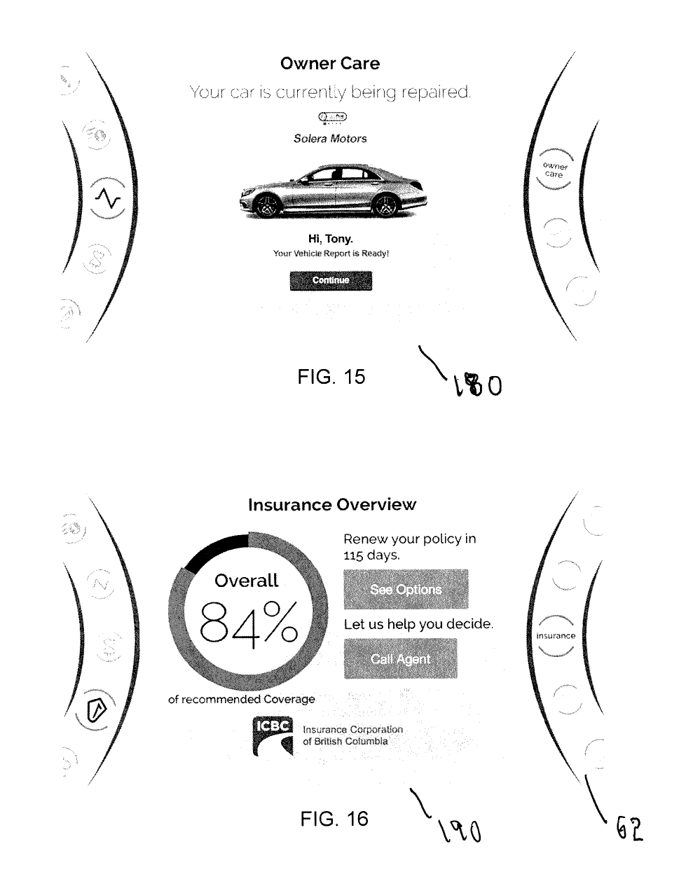

FIG. 12 is a repairs needed screen shot 150 that includes selectable Recalls, Previously Declined Service and Upcoming Potential Repair icons. The user can click on the Recalls icon which causes a link to a database(s) that collects recall information. The Previously Declined Services and Upcoming Potential Repair icons can be selected to retrieve data regarding these topics. By way of example, the data can be provided by a dealer database. Planned future maintenance and a service schedule can be provided by screen shots 160 and 170, shown in FIGS. 13 and 14, respectively. The cost of future maintenance can be provided to the user. FIG. 15 provides a screen shot 180 with a Continue button that can be selected to display further screens that provide a status of a vehicle repair. This information can be obtained by connection to a garage or dealer database.

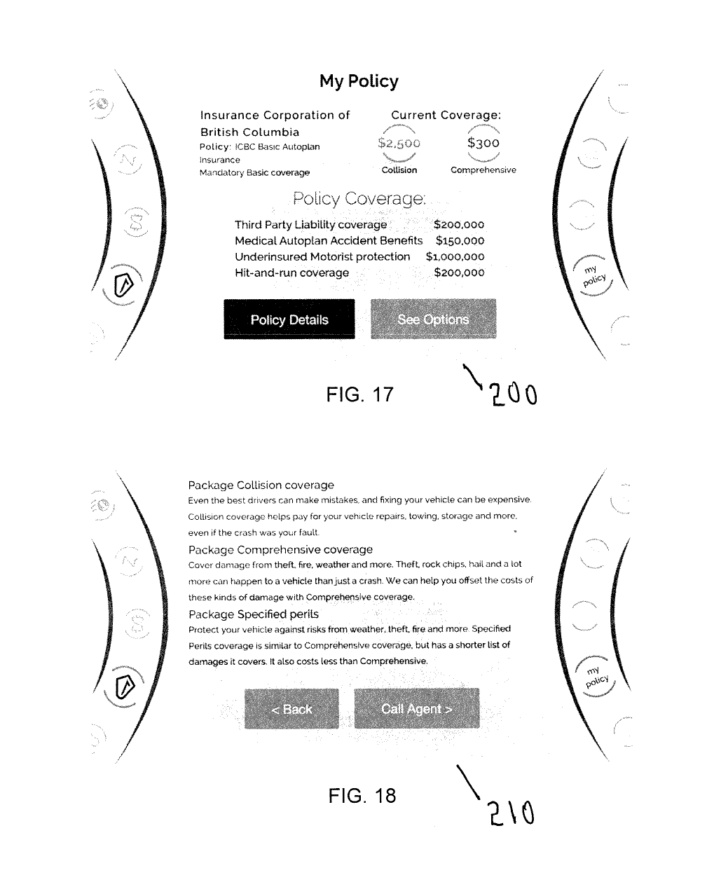

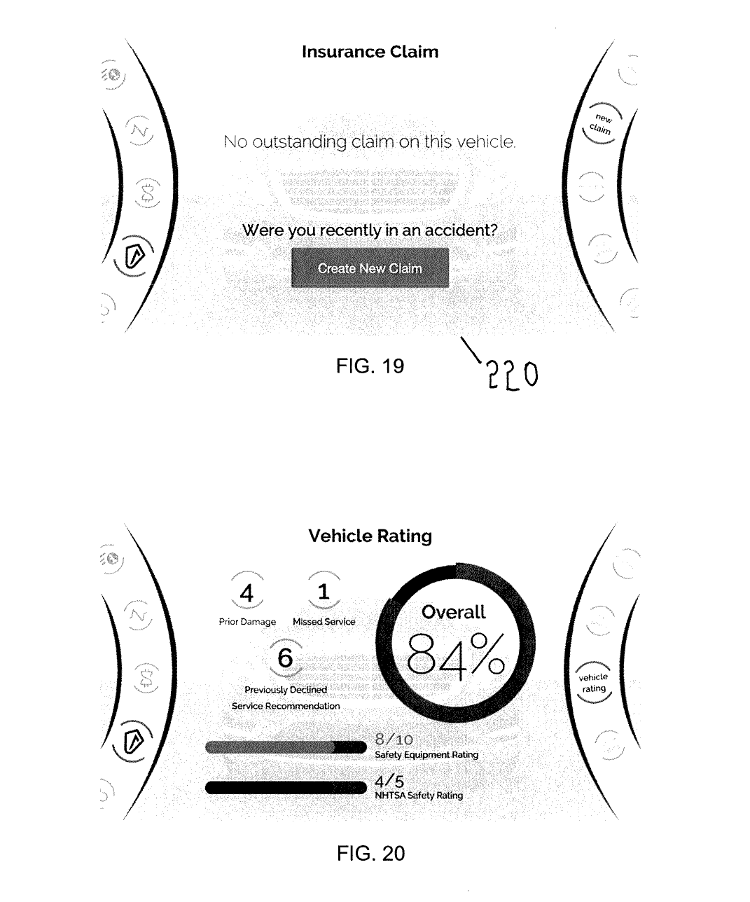

FIG. 16 shows a screen shot 190 wherein the right graphical wheel 62 has been moved to select information on vehicle insurance. The insurance data can be accessed by connecting to an insurance carrier database. The screen 190 may include a link to the user's insurance company web page. FIG. 17 shows a screen shot 200 that provides various coverage data. This screen 200 can be displayed by moving the right graphical wheel 62 to illuminate a My Policy icon. FIG. 18 is a screen shot 210 that provides insurance information regarding additional packages. FIG. 19 is a screen shot 220 with a Create New Claim button that can be selected to file an new insurance claim. Selection of the button can connect the user to an insurance carrier system.

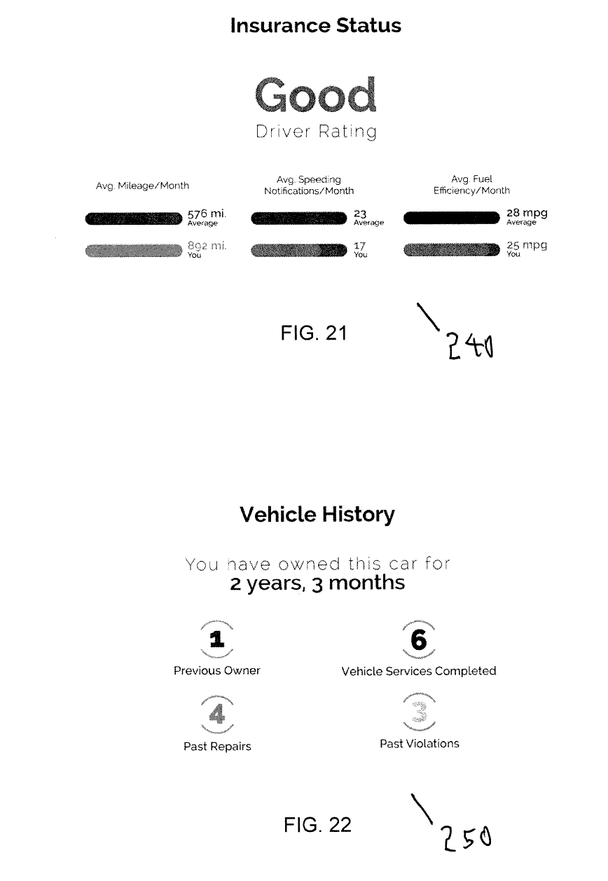

FIG. 20 shows a screen shot 230 that provides a vehicle rating (“Overall 84%”) relative to a potential insurance premium. The vehicle rating can be a custom 0-100 score that is a function of current safety and vehicle health assumptions based on maintenance and repair history compared to recommendations. The screen 230 can also provide a safety equipment rating and a NHTSA safety rating, along with other service and damage information. FIG. 21 shows a screen shot 240 that provides an indication of a driver rating with relevant data such as average mileage and driving speed. This information can be provided by ODB2 data from the vehicle. The driver rating can be a custom 0-100 score that is a function of experience and safety assumptions of a driver based on driving history (e.g. miles driven, locations driven, driving behavior, etc.), violations and accident history.

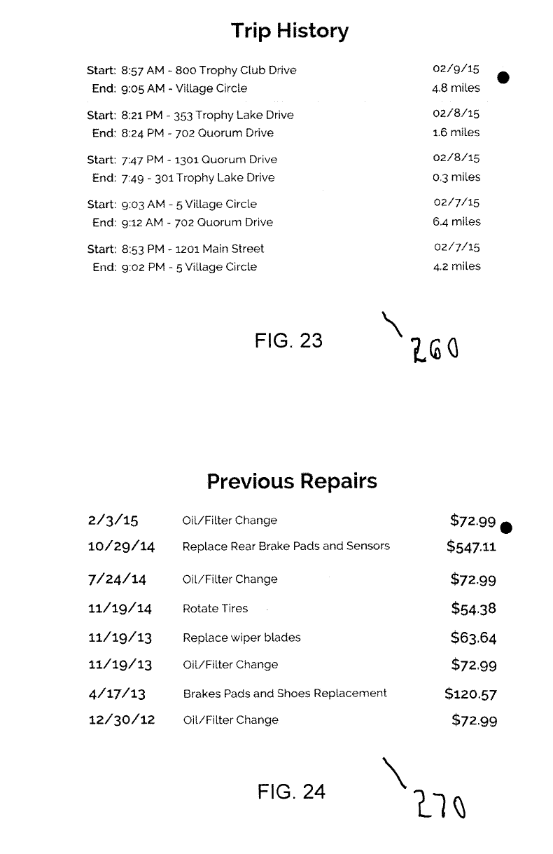

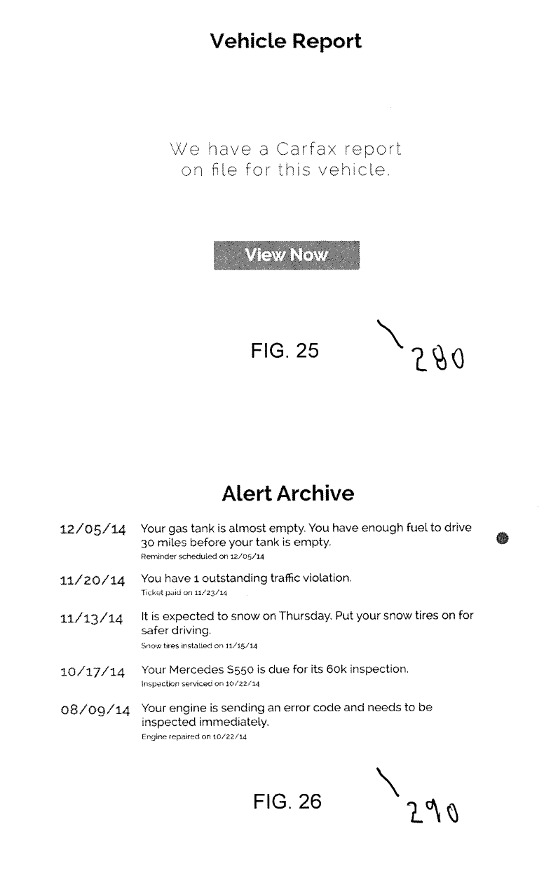

Manipulation of the left and right graphical wheels 62 and 64 shown in FIG. 3, can provide screen shots 250, 260, 270, 280, 290, 300 and 310 shown in FIGS. 22-28, respectively. FIG. 22 shows a screen shot 240 that provides vehicle history. The screen 250 may have icons that can be selected to retrieve relevant vehicle history such as past repairs and past violations. FIG. 23 shows screen 260 that list a trip history for the vehicle. The trip history can be generated from ODB2 vehicle data. Screen shot 270 shown in FIG. 24 provides previous repair data that can be accessed from a garage(s) and dealer database(s) and stored in module 12. FIG. 25 shows a screen 280 that provides a link to a vehicle report provider.

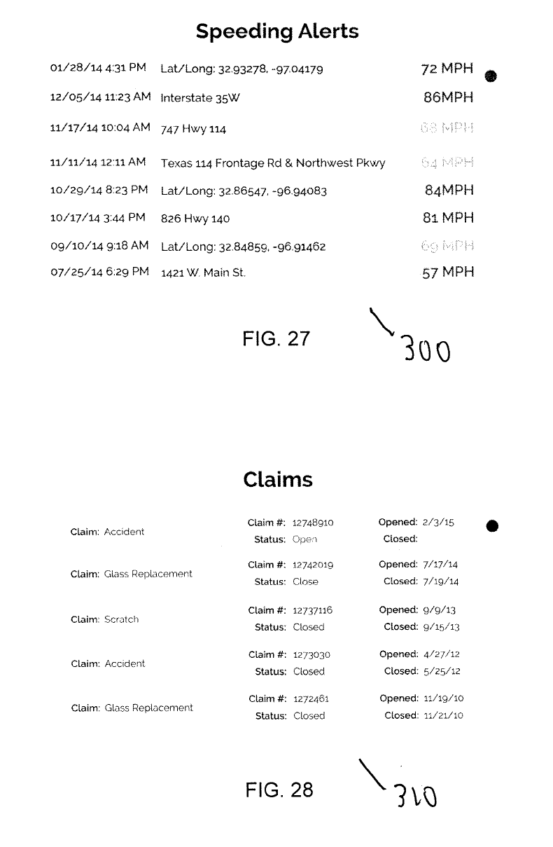

The screen shot 290 shown in FIG. 26 shows a collection of alert data such as fuel level, outstanding traffic violations and the local weather. This data can be retrieved from various relevant databases and accessed through the portal server. FIG. 27 shows a screen shot 300 that provides speeding alerts based on ODB2 vehicle data. FIG. 28 shows a screen shot 310 that provides previous insurance claim data that can be retrieved from an insurance carrier database.

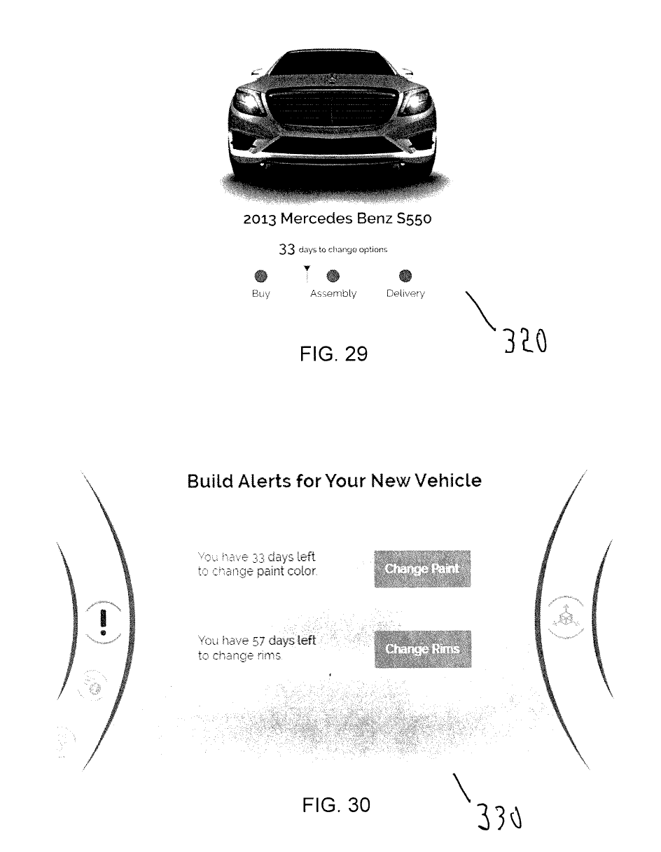

FIG. 29 shows a screen shot 320 with selectable icons

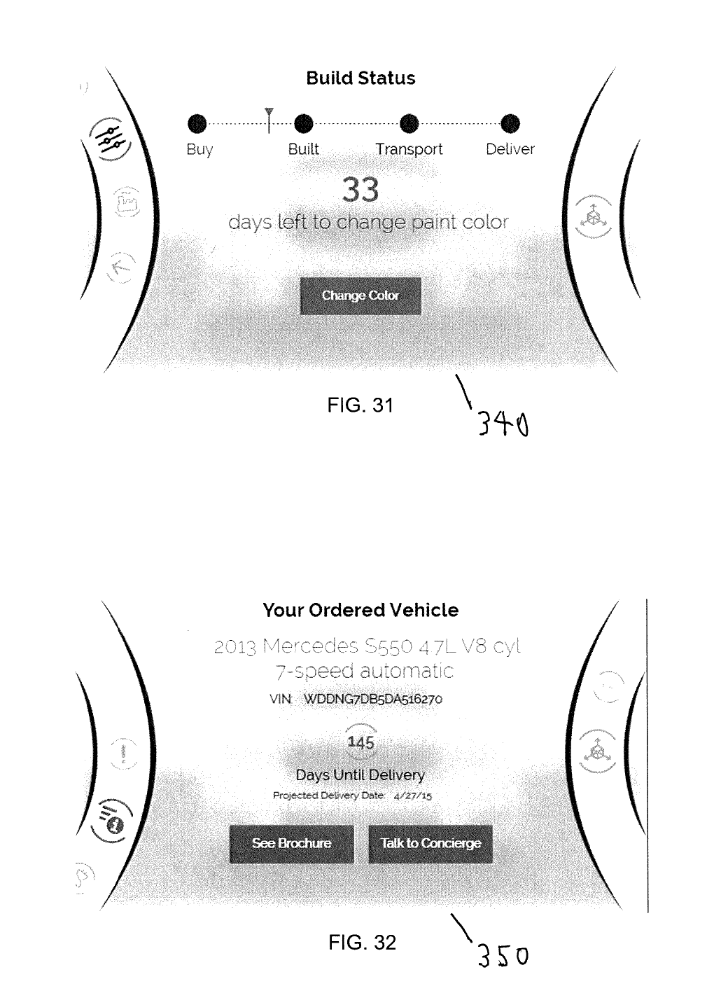

Buy, Assembly and Delivery that relate to the build of a new vehicle. Selecting the Buy icon can cause the display of various screens to purchase a vehicle. Selecting the Assembly icon can case the display of various screens associated with the vehicle. This information can be provided by a manufacturer database. FIG. 30 shows a screen shot 330 with selectable buttons that allows the user to change or update the ordered vehicle configuration and delivery options of such as paint color or wheel selection. Selections are made available within a time frame for which the user may make such modifications. FIG. 31 shows a screen shot 340 that provides an overview of the build status of the vehicle that can be provided by accessing data from the manufacturer assembly process.

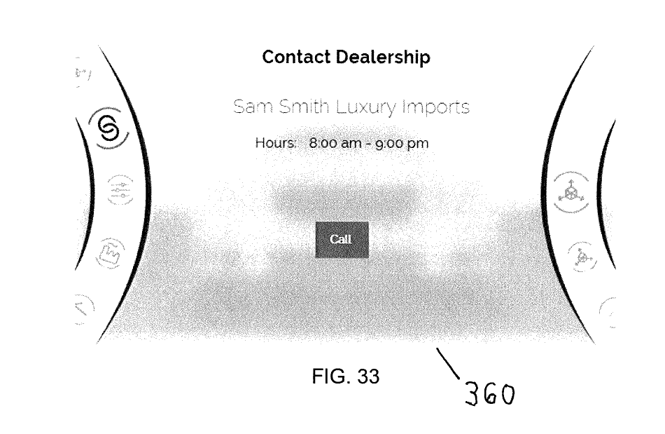

Referring again to FIG. 29, selection of the Delivery icon can cause the display of various screens that relate to delivery of the vehicle. FIG. 32 shows a screen shot 350 that provides delivery information for the vehicle that can be provided by the manufacturer. FIG. 33 shows a screen shot 360 that allows a user to contact a dealership regarding the delivery of the vehicle.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus that provides access to a plurality of vehicle subjects, comprising:
a device that includes memory and a CPU that operates a vehicle access application, said vehicle access application provides vehicle subjects such as information regarding an owned vehicle and information regarding a not owned vehicle.

2. The apparatus of claim 1, wherein said vehicle access application provides at least one graphical wheel that can be manipulated to display different vehicle subjects.

3. The apparatus of claim 1, wherein said vehicle access application provides information regarding vehicle insurance.

4. The apparatus of claim 1, wherein said vehicle access application provides information regarding a vehicle history.

5. The apparatus of claim 1, wherein said vehicle access application provides information regarding vehicle value and vehicle financing.

6. The apparatus of claim 1, wherein said vehicle access application provides interfaces that allow a user to purchase a vehicle.

7. A non-transitory computer program storage medium, comprising computer-readable instructions for providing access to a plurality of vehicle subjects, execution of said computer-readable instructions by at least one processor performs the steps:
receiving owned vehicle input on an interface provided by a vehicle access application;
providing information regarding an owned vehicle;
receiving not owned vehicle input on an interface provided by said vehicle access application; and,
providing information regarding an not owned vehicle.

8. The non-transitory computer program storage medium of claim 7, wherein said vehicle access application provides at least one graphical wheel that can be manipulated to display different vehicle subjects.

9. The non-transitory computer program storage medium of claim 7, wherein said vehicle access application provides information regarding vehicle insurance.

10. The non-transitory computer program storage medium of claim 7, wherein said vehicle access application provides information regarding a vehicle history.

11. The non-transitory computer program storage medium of claim 7, wherein said vehicle access application provides information regarding vehicle value and vehicle financing.

12. The non-transitory computer program storage medium of claim 7, wherein said vehicle access application provides interfaces that allow a user to purchase a vehicle.

13. A method for providing access to a plurality of vehicle subjects, comprising:
receiving owned vehicle input on an interface provided by a vehicle access application;
providing information regarding an owned vehicle;
receiving not owned vehicle input on an interface provided by said vehicle access application; and,
providing information regarding an not owned vehicle.

14. The method of claim 13, wherein said vehicle access application provides at least one graphical wheel that can be manipulated to display different vehicle subjects.

15. The method of claim 13, wherein said vehicle access application provides information regarding vehicle insurance.

16. The method of claim 13, wherein said vehicle access application provides information regarding a vehicle history.

17. The method of claim 13, wherein said vehicle access application provides information regarding vehicle value and vehicle financing.

18. The method of claim 13, wherein said vehicle access application provides interfaces that allow a user to purchase a vehicle.
